(19) United States
(12) Patent Application Publication
(10) Pub. No.: US 2014/0270060 A1
(43) Pub. Date: Sep. 18, 2014

(54) X-RAY TALBOT INTERFEROMETER AND X-RAY TALBOT IMAGING SYSTEM

(71) Applicant: CANON KABUSHIKI KAISHA, Tokyo (JP)

(72) Inventors: Takashi Date, Kawasaki-shi (JP); Genta Sato, Kawasaki-shi (JP); Chidane Ouchi, Utsunomiya-shi (JP)

(73) Assignee: CANON KABUSHIKI KAISHA, Tokyo (JP)

(21) Appl. No.: 14/203,279

(22) Filed: Mar. 10, 2014

(30) Foreign Application Priority Data
Mar. 13, 2013 (JP) 2013-050558

(51) Int. Cl. G01N 23/20

(52) U.S. Cl. CPC G01N 23/20075
USPC 378/36

(57) ABSTRACT

An X-ray Talbot interferometer includes a source grating configured to spatially split X-rays emitted from an X-ray source, a diffraction grating configured to form an interference pattern with the X-rays from the source grating, and an X-ray detector configured to detect the X-rays from the diffraction grating. The X-ray Talbot interferometer further includes an angle varying unit configured to vary an angle formed by an optical axis, which is the center of a flux of the X-rays from the X-ray source, and the source grating. The angle varying unit varies the angle formed by the optical axis and the source grating from a first angle to a second angle. The X-ray detector detects the X-rays at least when the optical axis and the source grating form the first angle and when the optical axis and the source grating form the second angle.

### BACKGROUND OF THE INVENTION

1. Field of the Invention

The present invention relates to X-ray Talbot interferometers and X-ray Talbot imaging systems for capturing images of objects.

2. Description of the Related Art

The Talbot-Lau interferometry, which is based on the principles of Talbot interference, utilizes a phase difference of X-rays (phase contrast method) generated by an inspection object. An example of Talbot-Lau interferometry is described in Japanese Patent Application Laid-Open No. 2007-203066. Typically, in X-ray Talbot-Lau interferometry, an X-ray Talbot interferometer includes a source grating for splitting X-rays from an X-ray source, a diffraction grating for diffracting the X-rays from the source grating, and an X-ray detector for detecting the X-rays from the diffraction grating.

The source grating may be capable of improving spatial coherence of the X-rays by splitting the X-rays from the X-ray source into small beams. The diffraction grating can diffract the X-rays to form an interference pattern (hereinafter, referred to as a self-image in some cases) through the Talbot effect. A phase type diffraction grating (phase grating) or an amplitude type diffraction grating may be used as the diffraction grating. The X-ray detector can obtain information on an X-ray intensity distribution by detecting the X-rays from the diffraction grating. When the inspection object is placed between the source grating and the diffraction grating or between the diffraction grating and the X-ray detector, the X-rays are modulated by the inspection object, and thus a self-image is modulated by the inspection object. As the self-image is modulated by the inspection object in this manner, that self-image includes information on the inspection object. Carrying out various operations on the information on the self-image, as necessary, makes it possible to obtain information on the inspection object. The Talbot interferometer that utilizes the Talbot-Lau method captures an image of the inspection object by detecting the self-image that has been modulated by the inspection object through the X-ray detector.

Typically, a self-image has a very short period, and thus it is difficult to directly detect the self-image with an X-ray detector. Thus, a method has been proposed in which a shield grating is disposed at a location at which a self-image is to be formed and a pattern (moire) having a period longer than that of the self-image is formed thereon. This pattern is then detected with an X-ray detector. In the case in which the shield grating is used, an image of an inspection object can be captured by detecting the pattern formed by the self-image and the shield grating with the X-ray detector.

In the X-ray Talbot interferometer that utilizes the Talbot-Lau method, each of the diffraction grating, the source grating, and the shield grating has a structure in which phase shift portions or shielding portions, each having a thickness necessary to fulfill its function, are arranged at a fine pitch. Thus, each of the phase shift portions and the shielding portions has a large aspect ratio. Note that the aspect ratio is the ratio of the height to the width of the portions. In addition, in order to increase an imaging range, it is desirable to use a large-sized diffraction grating, source grating, and shield grating. Since the diffraction grating, the source grating, and the shield grating are generally arranged between the X-ray source and the X-ray detector along an optical axis, in areas on each grating which are spaced apart from the optical axis, X-rays are incident at an angle on a phase shift portion or a shielding portion having a large aspect ratio. Consequently, depending on the sizes of these gratings, the aspect ratio of the phase shift portion or of the shielding portion, and the angle of incidence of the X-rays, the gratings may not fulfill their functions, and the contrast of the self-image or the moire to be formed may decrease. As the contrast of the self-image or the moire decreases, it becomes harder to obtain information on the inspection object through areas of the gratings that are further spaced apart from the optical axis.

To address such an issue, Japanese Patent Application Laid-Open No. 2007-203066 proposes a configuration in which phase shift portions of a diffraction grating and shielding portions of a source grating and of a shield grating are formed so as to be parallel to incident X-rays.

In the source grating described in Japanese Patent Application Laid-Open No. 2007-203066, the shielding portions need to be directed in specific directions in accordance with their positions along the surface of the grating, and in particular, it is not easy to fabricate such a source grating, which is to be disposed at a short distance from an X-ray source.

In addition, Japanese Patent Application Laid-Open No. 2007-203064 proposes a configuration in which gratings are curved so that phase shift portions of a diffraction grating and shielding portions of a source grating and of a shield grating are positioned parallel to incident X-rays.

With the source grating described in Japanese Patent Application Laid-Open No. 2007-203064, the grating itself needs to be curved, and in particular, it is not easy to fabricate such a source grating, which is to be disposed at a short distance from an X-ray source.

### SUMMARY OF THE INVENTION

According to an aspect of the present invention, an X-ray Talbot interferometer includes a source grating configured to spatially split X-rays from an X-ray source, a diffraction grating configured to diffract the X-rays from the source grating to form an interference pattern, an X-ray detector configured to detect the X-rays from the diffraction grating, and an angle varying unit configured to vary an angle formed by an optical axis and at least one periodic direction of the source grating. The optical axis is a center of a flux of the X-rays from the X-ray source.

Further features of the present invention will become apparent from the following description of exemplary embodiments with reference to the attached drawings.

### BRIEF DESCRIPTION OF THE DRAWINGS

FIG. 1 illustrates an overall configuration of an X-ray Talbot interferometer system according to a first exemplary embodiment.

FIG. 2 is an enlarged view of an X-ray Talbot interferometer according to the first exemplary embodiment.

FIG. 3 is an illustration for describing rotation of a source grating according to the first exemplary embodiment.

FIG. 4 is another illustration for describing rotation of the source grating according to the first exemplary embodiment.

FIG. 5 is an illustration for describing rotation and translation of the source grating according to the first exemplary embodiment.

FIG. 6 is an enlarged view of an X-ray Talbot interferometer according to a second exemplary embodiment.

FIG. 7 is an illustration for describing rotation and translation of a source grating according to the second exemplary embodiment.

FIG. 8 is an illustration for describing rotation and translation of a source grating, a diffraction grating, a shield grating, and an X-ray detector according to a third exemplary embodiment.

FIG. 9 illustrates a configuration of an X-ray Talbot interferometer according to an exemplary embodiment.

FIG. 10 is a schematic diagram of a phase grating according to the exemplary embodiment.

FIG. 11 is a schematic diagram of a source grating according to the exemplary embodiment.

FIG. 12 is a schematic diagram of a shield grating according to the exemplary embodiment.

FIG. 13 illustrates a transmittance distribution of the source grating, in an initial state, according to the exemplary embodiment.

FIG. 14 illustrates a transmittance distribution of the source grating according to the exemplary embodiment, in a case in which X-rays are incident normally on the source grating at a position where X=4.5 mm and Y=0 mm.

FIG. 15 illustrates a transmittance distribution of the source grating according to the exemplary embodiment, in a case in which X-rays are incident normally on the source grating at a position where X=4.5 mm and Y=4.5 mm.

FIG. 16 illustrates a transmittance distribution of the source grating, in an integrated image, according to the exemplary embodiment, in a case in which X-rays are incident normally on the source grating at nine positions along the surface of the source grating.

### DESCRIPTION OF THE EMBODIMENTS

Hereinafter, exemplary embodiments of the present invention will be described with reference to the appended drawings. In the drawings, identical members are given identical reference numerals, and duplicate descriptions thereof will be omitted. In the present specification, an optical axis (X-ray axis) refers to the center of a light flux (X-ray flux), and a periodic direction of a source grating refers to a direction in which shielding portions and transmissive portions are arranged periodically in the source grating.

The exemplary embodiments, while focusing in particular on a source grating, disclose an X-ray Talbot interferometer that, while using a planer shaped source grating that includes shielding portions which are arranged perpendicularly to the surface of the grating, is capable of improving contrast of a self-image or moire in areas of the source grating which are spaced apart from an optical axis, as compared to existing X-ray Talbot interferometers. A source grating that includes shielding portions which are arranged perpendicularly to the surface of the grating can be fabricated more easily than the source gratings described in Japanese Patent Application Laid-Open No. 2007-203066 and Japanese Patent Application Laid-Open No. 2007-203064.

### First Exemplary Embodiment

According to a first exemplary embodiment, an X-ray Talbot interferometer includes an angle varying unit configured to vary an angle formed by an optical axis and a periodic direction of a source grating (hereinafter, referred to as an angle formed by an optical axis and a source grating in some cases) from a first angle to a second angle. In the exemplary embodiments of the present invention, an angle formed by an optical axis of the light flux and a periodic direction of a source grating refers to an angle formed by the optical axis with respect to the periodic direction of the source grating. When the angle formed by the source grating and the optical axis is at the first angle, X-rays are incident normally on the source grating at the center of a first area of the source grating. Meanwhile, when the angle formed by the source grating and the optical axis is at the second angle, X-rays are incident normally on the source grating at the center of a second area of the source grating. Varying the angle formed by the source grating and the optical axis while X-rays are being detected (i.e., during exposure) allows a single detection result to include information on an intensity distribution (self-image or moire) obtained when there is a sharp contrast in an area corresponding to the first area and information on an intensity distribution obtained when there is a sharp contrast in an area corresponding to the second area. Alternatively, a similar effect can be obtained even by separately carrying out detection when the angle formed by the source grating and the optical axis is at the first angle and detection when the angle formed by the source grating and the optical axis is at the second angle and then by combining the two detection results.

Hereinafter, the X-ray Talbot interferometer of the first exemplary embodiment will be described in further detail.

FIG. 1 illustrates an overall configuration of the X-ray Talbot interferometer of the first exemplary embodiment.

An X-ray Talbot interferometer 110 of the first exemplary embodiment includes a source grating 2 configured to spatially split X-rays from an X-ray source, a phase grating 4, which is a phase type grating, serving as a diffraction grating for diffracting the X-rays from the source grating 2 to form an interference pattern, and an X-ray detector 6 configured to detect the X-rays from the phase grating 4. The X-ray Talbot interferometer 110 further includes a shield grating 5 configured to block part of the X-rays that form the interference pattern, and a moire is thus formed from the interference pattern through the shield grating 5. In the present specification, an intensity distribution formed while part of the X-rays that are to form the interference pattern is blocked is referred to as moire, and such an intensity distribution is referred to as moire even when, for example, its period is of an infinite length or of a length that is as close as possible to an infinite length. The X-ray detector 6 of the X-ray Talbot interferometer 110 of the first exemplary embodiment detects X-rays that have passed through the diffraction grating and the shield grating 5. It is still considered that the X-ray detector 6 detects X-rays from the diffraction grating even in a case in which the X-rays from the diffraction grating are not directly incident on the X-ray detector 6 as described above.

The X-ray Talbot interferometer 110 of the first exemplary embodiment further includes an actuator 10 serving as an angle varying unit configured to vary an angle formed by an optical axis and a periodic direction of the source grating 2. To that end, the actuator 10 is operably connected to the source grating 2. The actuator 10, which is connected to the source grating 2, moves the source grating 2 in accordance with an instruction from a control unit 8 so as to vary the angle formed by the optical axis and the source grating 2. The actuator 10 also functions as a distance varying unit configured to vary the distance between the X-ray source and the source grating 2 (i.e., the distance between the center of an X-ray generation area of the X-ray source and the center of an X-ray irradiation area of the source grating 2). In other words, the actuator 10, which is connected to the source grating 2, can vary both the angle formed by the source grating 2 and the optical axis and the distance between the source grating 2 and the X-ray source by moving the source grating 2.

In addition, the X-ray Talbot interferometer 110 of the first exemplary embodiment, an X-ray source 1, and a calculator 7 form an X-ray Talbot interferometer system. The calculator 7 serves as an operation unit that carries out various operations using results of detection by the X-ray detector 6. Although not illustrated, the X-ray Talbot interferometer system may further include an image display unit configured to display an image based on a result of an operation by the operation unit.

Hereinafter, the structure and configuration of each unit will be described.

The X-ray source 1 of the first exemplary embodiment is a divergent X-ray source (cone beam X-ray source) having a focal spot size of approximately a few hundred micrometers to a few millimeters, which is typically used in a laboratory, a medical setting, and so on. X-rays in the present specification refers to electromagnetic waves having energy of 2 keV to 100 keV.

A wavelength selection filter or the like may be disposed in an optical path of the X-rays emitted from the X-ray source 1.

The source grating 2 of the first exemplary embodiment is a two-dimensional source grating in which transmissive portions that transmit X-rays and shielding portions that block X-rays are arranged periodically in two directions, namely, in a first direction and a second direction that intersects with the first direction. In a case in which a one-dimensional diffraction grating is used, however, a one-dimensional source grating may be used. Even in a case in which a two-dimensional diffraction grating is used, a one-dimensional source grating may be used if it is sufficient that spatial coherence be improved only in one direction.

By setting each of the pitches of the transmissive portions and of the shielding portions in the source grating 2 to approximately a few micrometers to a few tens of micrometers, X-rays emitted from the X-ray source 1 are split into rays having a pitch in a range from a few micrometers to a few tens of micrometers, and the spatial coherence of the X-rays from the X-ray source 1 is improved. In this manner, the use of the source grating 2 makes it possible to use an X-ray source having a relatively large focal spot size of approximately a few hundred micrometers. Although the shielding portions do not need to block X-rays completely, it is preferable that the shielding ratio thereof be high, in order to improve the spatial coherence.

The diffraction grating of the first exemplary embodiment is a phase grating 4, which is a phase type diffraction grating, and diffracts the X-rays from the source grating 2 to form an interference pattern (self-image) in which light portions and dark portions are arranged periodically. Although it is also possible to use an amplitude type diffraction grating as the diffraction grating, a phase type diffraction grating is advantageous because the phase type diffraction grating causes a smaller amount of X-ray loss. The phase grating 4 of the first exemplary embodiment is a two-dimensional phase grating in which phase shift portions and phase reference portions are arranged periodically in two directions that are orthogonal to each other and diffracts the X-rays from the source grating 2 to form a two dimensional interference pattern. As long as the directions in which phase shift portions and phase reference portions are arranged periodically (i.e., periodic directions) intersect with each other, although not necessarily orthogonally to each other, such a phase grating is referred to as a two-dimensional phase grating. The phase of X-rays that have passed through a phase shift portion is shifted by a predetermined amount relative to the phase of X-rays that have passed through a phase reference portion. Although a phase grating having a phase shift amount of it radians or π/2 radians is typically used, a phase grating having a shift amount different from the above can also be used. It is preferable that the material for forming the phase grating 4 be a substance having high transmittance of X-rays, and silicon, for example, can be used.

The shield grating 5 of the first exemplary embodiment is a two-dimensional shield grating in which transmissive portions that transmit X-rays and shielding portions that block X-rays are arranged periodically in two directions that are orthogonal to each other. As long as the directions in which transmissive portions and shielding portions are arranged periodically (i.e., periodic directions) intersect with each other, although not necessarily orthogonally to each other, such a shield grating is referred to as a two-dimensional shield grating. In addition, the shielding portions do not need to block X-rays completely. The shielding portions, however, need to block X-rays to a degree that allows moire to be formed by overlaying the shield grating 5 on an interference pattern. It is preferable that approximately 90% of X-rays that are incident normally on the shielding portions be blocked. The period of the shield grating 5 can be identical to or slightly different from the period of an interference pattern to be formed on the shielding grating 5 by the diffraction grating and can be determined on the basis of the period of desired moire to be formed.

The period of a self-image formed through X-ray Talbot interferometry is typically finer than the spatial resolution of a typical X-ray detector, and it is difficult to detect an intensity distribution of the self-image directly with an X-ray detector. Thus, there exists a method in which moire having a period that is greater than the period of a self-image is formed by using a shield grating having a period that is slightly different from the period of the self-image or by using a shield grating having a period that is the same as the period of the self-image and slightly rotating the shield grating along a plane thereof. The resulting moire is then detected by an X-ray detector. Since the moire stores pattern changes of the self-image caused by an inspection object, analyzing, by using a calculator, the moire obtained through the X-ray detector makes it possible to obtain information pertaining to the changes in the self-image caused by the inspection object.

In a case in which a fringe scanning method as described in International Publication No. 2004/058070 is to be employed, for example, a shield grating having a period that is the same as that of a self-image can be used without being rotated along the plane thereof. In such a case, moire having a period of an infinite length is formed.

The shield grating 5 is disposed such that the distance between the phase grating 4 and the shield grating 5 is at a Talbot distance. Through this, a clear self-image is formed on the shield grating 5.

The X-ray detector 6 obtains information on moire by detecting the X-rays. In a case in which a self-image is to be detected directly without using the shield grating 5, the X-ray detector 6 obtains information on the self-image by detecting the X-rays. The X-ray detector 6 includes an imaging device (e.g., charge-coupled device (CCD)) capable of detecting an intensity distribution (i.e., self-image or moire) of the X-rays. The X-ray detector 6 of the first exemplary embodiment is in close contact with the shield grating 5 while being parallel to the shield grating 5.

The calculator 7 serving as the operation unit calculates information on the inspection object on the basis of the result of detection by the X-ray detector 6. The information on the inspection object may, for example, be information on a phase image or on a differential phase contrast image of the inspection object or may be information on a scattering image or on an absorption image.

The rotation of the source grating 2 by the angle varying unit and the change in the angle formed by the source grating 2 and the optical axis will now be described with reference to FIGS. 2 and 3. The X-ray Talbot interferometer 110 of the first exemplary embodiment includes the actuator 10 serving as the angle varying unit, and the actuator 10 is connected to the source grating 2. The actuator 10 varies the angle formed by the source grating 2 and the optical axis by rotating the source grating 2.

Although the X-ray Talbot interferometer 110 of the first exemplary embodiment causes the angle formed by the source grating 2 and the optical axis to vary by using the actuator 10, such a point is not essential in the description of the principle of the first exemplary embodiment, and thus the description of the actuator 10 will be omitted.

In FIGS. 2 and 3, X-rays from the X-ray source 1 pass through the source grating 2 and an inspection object 3, and the X-rays that have passed through the inspection object 3 are diffracted by the phase grating 4. Thus, a self-image is formed on the shield grating 5. Part of the self-image formed on the shield grating 5 is blocked by the shielding portions of the shield grating 5, and thus moire is formed. The moire is then detected by the X-ray detector 6. Each of the source grating 2, the phase grating 4, the shield grating 5, and the X-ray detector 6 is disposed such that its point of intersection with an optical axis 20 coincides with the center of the X-ray irradiation area thereof. The angle varying unit causes the source grating 2 to rotate about the point of intersection of the optical axis 20 and the source grating 2 to thus vary the angle formed by the source grating 2 and the optical axis 20.

In FIG. 2, each of the source grating 2, the phase grating 4, the shield grating 5, and the X-ray detector 6 is disposed to be perpendicular to the optical axis 20. Here, a state of being disposed to be perpendicular to the optical axis 20 indicates that the source grating 2, the phase grating 4, and the shield grating 5 are disposed such that the periodic direction (or the two periodic directions, in the case of a two-dimensional grating) of each of the grating 2, the phase grating 4, and the shield grating 5 is perpendicular to the optical axis 20.

In this case, X-rays traveling along the optical axis 20 (hereinafter, referred to as center X-rays in some cases) are incident normally on the shield grating 5 at a center R0 of the X-ray irradiation area of the shield grating 5, on the phase grating 4 at a center Q0 of the X-ray irradiation area of the phase grating 4, and on the source grating 2 at a center P0 of the X-ray irradiation area of the source grating 2. Hereinafter, the center R0 of the X-ray irradiation area of the shield grating 5 may be referred to as the center of the shield grating 5 in some cases. The center of the shield grating 5 is the point of intersection of the optical axis 20 and the shield grating 5. In a similar manner, the center Q0 of the X-ray irradiation area of the phase grating 4 may be referred to as the center of the phase grating 4 in some cases. The center of the phase grating 4 is the point of intersection of the optical axis 20 and the phase grating 4. In a yet similar manner, the center P0 of the X-ray irradiation area of the source grating 2 may be referred to as the center of the source grating 2 in some cases. The center of the source grating 2 is the point of intersection of the optical axis 20 and the source grating 2. In this manner, when the X-rays traveling along the optical axis 20 are incident normally on the source grating 2 at the center P0 of the source grating 2, the thickness direction of the shielding portions or of the transmissive portions of the source grating 2 coincides with the traveling direction of the X-rays traveling along the optical axis 20 at the center P0 of the source grating 2. In such a case, vignetting (i.e., blocking of X-rays that are supposed to be transmitted by design) by the shielding portions of the source grating 2 hardly occurs in the vicinity of the center P0 of the source grating 2, and thus the center X-rays that have been incident on the source grating 2 at the center P0 form moire having a sharp contrast on the X-ray detector 6. Meanwhile, X-rays 21 at an edge of a light flux excluding the X-rays traveling along the optical axis 20 (hereinafter, referred to as peripheral X-rays in some cases) are incident at an angle on the source grating 2 at P1, and thus vignetting occurs. In a similar manner, peripheral X-rays 22 are incident at an angle on the source grating 2 at P2, and thus vignetting occurs. As a result, contrast of moire formed on the X-ray detector 6 decreases in an area corresponding to an area on the surface of each grating which is farther from the optical axis 20.

In order to make the contrast of the intensity distribution detected by the X-ray detector 6 in an area corresponding to R1 of the shield grating 5 clearer, the source grating 2 is rotated about the center P0 of the source grating 2 by an angle θ from the state illustrated in FIG. 2. The angle θ is an amount expressed through Expression (1).

$$θ = {tan}^{- 1} ( \frac{{\text{?}}_{\text{?} \text{?}}}{\text{?} \text{?}} ) \\ \text{?} \text{indicates text missing or illegible when filed} \qquad ( 1 )$$

Here, L0 represents the distance between the X-ray source 1 and the center P0 of the source grating 2, and d_{P0P1} represents the distance between the center P0 of the source grating 2 and P1 on the source grating 2.

Through this, the source grating 2, the phase grating 4, the shield grating 5, and the X-ray detector 6 have a positional relationship as illustrated in FIG. 3, and a first direction 120 of the source grating 2 and the optical axis 20 form an angle of (90°−θ). Then, the peripheral X-rays 21 are incident normally on the source grating 2 at P11, which is an edge of the X-ray irradiation area, and vignetting in the vicinity of P11 is thus reduced as compared with that in the state illustrated in FIG. 2. Consequently, the peripheral X-rays 21 form moire having a sharp contrast on the X-ray detector 6 as compared to that in the state illustrated in FIG. 2. In a case in which the two-dimensional source grating 2 is used, as in the first exemplary embodiment, it is preferable that not only the angle formed by the first direction 120 of the source grating 2 and the optical axis 20 but also an angle formed by a second direction 130 and the optical axis 20 be varied in a similar manner.

Here, the first area, the second area, the first angle, and the second angle described above are illustrated in FIGS. 2 and 3 as follows. The center of the first area corresponds to P0; the center of the second area corresponds to P1; the first angle is 90°; and the second angle is (90°−θ).

In this manner, the angle varying unit causes the angle formed by the optical axis 20 and the source grating 2 to vary, making it possible to create a state in which occurrence of vignetting at each of a plurality of areas (e.g., first area and second area) on the source grating 2 is reduced. As can be seen from FIG. 3, however, P1, at which the peripheral X-rays 21 are incident on the source grating 2 when the source grating 2 is disposed to be perpendicular to the optical axis 20, does not coincide with P11, at which the peripheral X-rays 21 are incident on the source grating 2 when the source grating 2 is disposed at an angle of (90°−θ) relative to the optical axis 20. In other words, the position of an aperture portion of the source grating 2 which functions as an imaginary X-ray source (focal point) changes along with a change in the angle formed by the source grating 2 and the optical axis 20. Consequently, the positions of light portions and dark portions in moire detected by the X-ray detector 6 in the state illustrated in FIG. 3 may differ from the positions of light portions and dark portions in moire detected in the state illustrated in FIG. 2.

In other words, the X-rays (here, the peripheral X-rays 21) emitted from the X-ray source 1 are incident on the source grating 2 at different positions (here, P1 and P11) in accordance with the change in the angle formed by the source grating 2 and the optical axis 20. Thus, a phenomenon in which the positions of light portions and dark portions in moire formed on the X-ray detector 6 change in accordance with the angle formed by the source grating 2 and the optical axis 20 (hereinafter, referred to as a fringe shift in some cases) may occur.

Meanwhile, rotating the source grating 2 by an angle θ₂ so that the peripheral X-rays 21 are incident normally on the source grating 2 at P1 leads to a state illustrated in FIG. 4. In FIG. 2, the peripheral X-rays 21 that have passed through the source grating 2 at P1 pass through the phase grating 4 at Q1 and through the shield grating 5 at R1. Meanwhile, in FIG. 4, the peripheral X-rays 21 that have passed through the source grating 2 at P1 pass through the phase grating 4 at Q11 and through the shield grating 5 at R11, and thus a fringe shift may occur in this case as well.

In FIG. 4, a fringe shift of a larger amount may occur at the side of R2, which is a position symmetrical to R1 (i.e., side at which X-rays that have passed through the shield grating 5 at primarily around P2 form moire). The contrast of moire, however, is low around R2 (i.e., an amount of the X-rays that pass through the shield grating 5 around P2 is small), and thus an influence of the fringe shift on the detection result to be obtained is negligibly small.

In order to reduce such a fringe shift as described above, it is preferable that the X-ray Talbot interferometer 110 of the first exemplary embodiment further include a distance varying unit configured to vary the distance between the X-ray source 1 and the source grating 2 in accordance with the change in the angle formed by the optical axis 20 and the source grating 2. A principle of how a fringe shift is resolved in an area corresponding to R1 in the X-ray detector 6 by using the distance varying unit will be described with reference to FIG. 5.

In FIG. 5, the source grating 2 has been translated along the optical axis 20 in accordance with the angle θ from the state illustrated in FIG. 3, and thus the distance between the X-ray source 1 and the source grating 2 has been changed. The amount of the change in the distance between the X-ray source 1 and the source grating 2 is represented by ΔL0 and is expressed through Expression (2) using L0.

$$Δ L 0 = L 0 \times ( \frac{1}{cos θ} - 1 ) \qquad ( 2 )$$

A distance d_{P0P11} between the point of intersection P11 of the source grating 2 and the peripheral X-rays 21 and the center P0 of the source grating 2 obtained after the source grating 2 has been translated is expressed through Expression (3).

d_{P0P11}=(L0+ΔL0)sin θ=L0 tan θ (3)

As can be seen from FIG. 2, since d_{P0P1}=L0 tan θ, d_{P0P1}=d_{P0P11}, and thus P11 and P1 coincide with each other. Therefore, a fringe shift does not occur.

Through this, it is understood that the X-rays that reach R1 of the shield grating 5 have passed through the source grating 2 at P1, after the source grating 2 has been translated. This situation is the same as that illustrated in FIG. 2, and thus the position of moire formed on the X-ray detector 6 does not differ between the state illustrated in FIG. 2 and the state illustrated in FIG. 5.

Although an example in which the angle formed by the optical axis 20 and the source grating 2 is changed from 90° to (90°−θ) has been described above, it is possible to suppress a fringe shift even when the stated angle is changed from another angle to yet another angle if the amount of the change in the angle is substituted for θ in Expression (2). Note that the amount of the change in the angle refers, for example, to a difference between the first angle and the second angle in the case in which the angle is changed from the first angle to the second angle.

As described thus far, rotating and translating the source grating 2 with the angle varying unit and the distance varying unit so as to satisfy Expression (1) and Expression (2) makes it possible to suppress vignetting by the source grating 2 in the vicinity of P1 and to increase the amount of X-rays to be transmitted, without changing the positions of light portions and dark portions in moire. Note that an actuator that is connected to an X-ray source or to a source grating can, for example, be used as the distance varying unit. Although the actuator 10 connected to the source grating 2 functions as both the angle varying unit and the distance varying unit in the first exemplary embodiment, each of these varying units may be provided independently.

In addition, in a case in which vignetting around a position aside from P1 (e.g., around P2) is to be suppressed, the distance between that position and P0 (e.g., d_{P0P2}) may be substituted for d_{P0P1} in Expression (1). In this manner, a position at which there is to be a sharp contrast of moire formed on a light-receiving surface of the X-ray detector 6 can be selected as desired. Accordingly, a position at which there is to be a sharp contrast may be moved across the light-receiving surface of the X-ray detector 6 in accordance with the principle described above while the X-rays are being detected by the X-ray detector 6. Through this, information on an inspection object can be obtained from the result of a single instance of detection even in a case in which the inspection object is relatively large. In order to achieve the above, the angle varying unit and the distance varying unit of the first exemplary embodiment continuously rotate and translate the source grating 2 as described above while the X-rays are being detected by the X-ray detector 6 (i.e., a position on the source grating at which the X-rays are incident normally thereon is moved continuously). As a result, contrast of moire detected at a peripheral portion of the light-receiving surface of the X-ray detector 6 can be improved, as compared with that of an existing technique. Here, the existing technique refers to a Talbot interferometer that detects X-rays only in a state in which a source grating, a phase grating, and a shield grating are arranged as illustrated in FIG. 2. In the first exemplary embodiment, the distance between the source grating 2 and the phase grating 4 varies. Therefore, although the distance between the phase grating 4 and the shield grating 5 may not satisfy the Talbot condition in a strict sense, θ is only a few degrees in X-ray Talbot interferometry, and thus degradation of contrast of the self-image is negligibly small.

Although the angle varying unit causes the angle formed by the optical axis 20 and the source grating 2 to vary by rotating the source grating 2 in the first exemplary embodiment, in a case in which the X-ray Talbot interferometer 110 includes the X-ray source 1, the angle varying unit may rotate the X-ray source 1 to cause the angle formed by the optical axis 20 and the source grating 2 to vary. In the case in which the X-ray source 1 is to be rotated, however, it is necessary to also translate the X-ray source 1 and the source grating 2. In that case, the field of view may become smaller than in a case in which the angle formed by the optical axis 20 and the source grating 2 is varied by rotating the source grating 2, or it may become necessary to use a source grating having a large area. Therefore, it is preferable to cause the angle formed by the optical axis 20 and the source grating 2 to vary by rotating the source grating 2.

In addition, although the source grating 2 is continuously moved (rotation and translation) while the X-ray detector 6 undergoes a single instance of detection in the first exemplary embodiment, it is sufficient that the X-ray detector 6 detect the X-rays at least while the angle formed by the source grating 2 and the optical axis 20 is at the first angle and while the stated angle is at the second angle.

In other words, the detection while the stated angle is at the first angle and the detection while the stated angle is at the second angle may be carried out in a single instance of detection as in the first exemplary embodiment, or the detection while the stated angle is at the first angle and the detection while the stated angle is at the second angle may be carried out in separate instances.

For example, as in a case of changing the angle formed by the source grating 2 and the optical axis 20 from the first angle to the second angle and carrying out detection in an alternating manner, movement of the source grating 2 to a given angle and detection of the X-rays by the X-ray detector 6 may be carried out in an alternating manner. In such a case, however, keeping a series of cycles of moving the source grating 2 and detecting the X-rays by the X-ray detector 6 shorter makes it possible to obtain images having more uniform contrast.

If the detection at the first angle and the detection at the second angle are carried out in separate instances, it is necessary to combine the results from the separate instances. Meanwhile, carrying out the detection at the first angle and the detection at the second angle in a single instance is advantageous because such a configuration does not require a process of combining the detection results and a detection result contains readout noise only from a single instance of readout. However, there may be a case in which it is easier to move the source grating 2 if the change in the angle and the detection are carried out in an alternating manner than in a case in which the change in the angle formed by the source grating 2 and the optical axis 20 and the change in the distance between the source grating 2 and the X-ray source 1 are carried out continuously. Therefore, which configuration is to be employed may be determined while taking the ease of moving the source grating 2 into consideration. Here, the detection refers to a state in which a detecting element of the X-ray detector 6 is in a state of detecting X-rays (i.e., state in which each element is in operation and an electric charge can be accumulated). For example, the X-ray detector 6 is considered to be in a state of detecting X-rays as long as the X-ray detector 6 is in a state of being capable of detecting X-rays, while the detecting element is not irradiated with the X-rays. This concept is equivalent to that in the following case. In general, when taking a picture with a camera, as long as the shutter is open and the imaging device (or film) is exposed to light from the lens, that state is considered as being under exposure regardless of whether or not the light is actually incident on the lens.

Aside from the above, there is another method for suppressing a fringe shift by shifting a rotational center about which the source grating 2 is rotated.

The source grating 2 is rotated by θ about the point of intersection P1 of the source grating 2 and the peripheral X-rays 21 from the state illustrated in FIG. 2. Then, the peripheral X-rays 21 are incident normally on the source grating 2 without the position at which the peripheral X-rays 21 are incident on the source grating being changed from that in the state illustrated in FIG. 2. In this manner, by rotating the source grating 2 about a position, serving as a rotational center, at which the X-rays are to be incident on the source grating 2 and by shifting the rotational center of the source grating 2 along the grating, a position at which there is to be a sharp contrast of moire formed on the X-ray detector 6 can be moved as desired. Although the X-rays that have passed through the rotational center do not cause a fringe shift to occur in principle with this method, a fringe shift may be more likely to occur at an area further spaced apart from the rotational center. As the distance from the rotational center increases, the amount of X-rays that pass through the source grating 2 decreases, and contrast of moire also decreases in turn. Therefore, an influence of such a fringe shift on the detection result may be ignored. It is considered, however, that the method for varying the distance between the X-ray source 1 and the source grating 2 as described with reference to FIG. 5 can better suppress an influence of a fringe shift on the detection result.

### Second Exemplary Embodiment

An X-ray Talbot interferometer of a second exemplary embodiment employs a curved grating for each of a phase grating and a shield grating, and the device configurations aside from the above, the method for rotating the source grating 2, the method for moving the source grating 2, and the method for capturing an image by the X-ray detector 6 are the same as those of the first exemplary embodiment.

The second exemplary embodiment will be described with reference to FIG. 6. FIG. 6 is a schematic diagram illustrating a state in which the source grating 2 is disposed to be perpendicular to the optical axis 20 in the second exemplary embodiment. Although only an influence of the source grating 2 on the angle of incidence of the X-rays has been considered in the first exemplary embodiment, angles at which the X-rays are incident on the phase grating and the shield grating also affect moire formed on the X-ray detector 6. For example, in the first exemplary embodiment, when the phase grating 4 and the shield grating 5 are disposed to be perpendicular to the optical axis 20, the traveling direction of the X-rays along the optical axis 20 coincides with the thickness direction of the phase reference portion or of the phase shift portion at the center Q0 of the phase grating 4. In addition, the traveling direction of the center X-rays also coincides with the thickness direction of the shielding portion or of the transmissive portion at the center R0 of the shield grating 5. However, the traveling direction of the peripheral X-rays 21 does not coincide with the thickness direction of the phase reference portion or of the phase shift portion at Q1 of the phase grating 4 and with the thickness direction of the shielding portion or of the transmissive portion at R1 of the shield grating 5. Therefore, the amount by which a phase is shifted may vary, or X-rays that are supposed to be transmitted may not be transmitted (i.e., vignetting may occur). Even with the first exemplary embodiment, which takes only the influence of the source grating 2 into consideration, the advantageous effect thereof is apparent as compared with the existing technique (corresponding to the method for capturing an image only in the state illustrated in FIG. 2).

The phase grating 4 and the shield grating 5, however, each have an area larger than that of the source grating 2, and thus it is preferable to take into consideration an influence of a relationship between each of the phase grating 4 and the shield grating 5 and an angle of incidence of the X-rays thereon.

Thus, in the second exemplary embodiment, the configuration is such that each of a phase grating 41 and a shield grating 51 has a curved shape, and irrespective of the angle of incident X-rays relative to the optical axis 20, a projection of each of the gratings is substantially parallel to the incident X-rays (i.e., the projection follows along the wavefront of the X-rays). FIG. 7 illustrates a state in which the source grating 2 has been rotated and moved. As described in the first exemplary embodiment, as the source grating 2 is moved by ΔL0 along the optical axis 20 of the X-rays in accordance with the change in the angle formed by the source grating 2 and the optical axis 20, the peripheral X-rays 21 that pass through the source grating 2 at P1 pass through the phase grating 41 at Q1 and through the shield grating 51 at R1. Thus, the trajectory of the peripheral X-rays in this case coincides with the trajectory of the peripheral X-rays 21 illustrated in FIG. 6. In other words, irrespective of the angle formed by the optical axis 20 and the source grating 2, the position (P1) at which the peripheral X-rays 21 are incident on the source grating 2 remains the same. Therefore, a fringe shift does not occur. This, however, applies in a case in which the source grating 2 is disposed such that the angle formed by the source grating 2 and the peripheral X-rays 21 at the position (P1) at which the peripheral X-rays 21 are incident on the source grating 2 is closer to being perpendicular than that in the state illustrated in FIG. 6 (i.e., so that vignetting decreases). A fringe shift occurs in a case in which the source grating 2 is disposed such that the angle formed by the source grating 2 and the peripheral X-rays 21 at the position (P1) at which the peripheral X-rays 21 are incident on the source grating 2 is closer to being parallel than that in the state illustrated in FIG. 6 (i.e., so that vignetting increases). However, since a large amount of X-rays has undergone vignetting in an area in which a fringe shift occurs, moire formed by the X-rays that have passed through the stated area has low contrast, and thus an influence of the fringe shift on the detection result is small.

With the X-ray Talbot interferometer of the second exemplary embodiment, since each of the phase grating 41 and the shield grating 51 has a curved shape, the peripheral X-rays 21 can be incident normally thereon at Q1 and R1.

The phase grating 41 and the shield grating 51 are spaced apart from the X-ray source 1 as compared with the source grating 2, and the radius of curvature of the wavefront of the X-rays is relatively large. Therefore, it is easier to prepare the curved phase grating 41 and the curved shield grating 51 as compared to a curved source grating.

By implementing the second exemplary embodiment, information on moire having more uniform contrast than that of the first exemplary embodiment can be obtained as a detection result.

### Third Exemplary Embodiment

In a third exemplary embodiment, the operations of rotating and moving the source grating 2 in the first exemplary embodiment are applied not only to the source grating 2 but also to the phase grating 4, the shield grating 5, and the X-ray detector 6.

The third exemplary embodiment will be described with reference to FIG. 8. As illustrated in FIG. 8, the source grating 2, the phase grating 4, the shield grating 5, and the X-ray detector 6 are rotated relative to the optical axis 20 by an angle that is the same as the angle by which the source grating 2 is rotated, and are moved along the optical axis 20 to change the distance from the X-ray source 1 so as to suppress occurrence of a fringe shift. Here, specific movement amounts are indicated below.

An amount of movement of the phase grating 4 is represented by ΔL1; an amount of movement of the shield grating 5 is represented by ΔL2; and an amount of movement of the X-ray detector 6 is represented by ΔL3. The amounts are then expressed through Expression (4) to Expression (6) below. Note that an amount of movement of the source grating 2 is ΔL0 as in Expression (2) above.

$$\begin{matrix} Δ L 1 = L 1 \times ( \frac{1}{cos {θ}_{Q}} - 1 ) & ( 4 ) \\ Δ L 2 = L 2 \times ( \frac{1}{cos {θ}_{\text{?}}} - 1 ) & ( 5 ) \\ Δ L 3 = L 3 \times ( \frac{1}{cos {θ}_{\text{?}}} - 1 ) \\ \text{?} \text{indicates text missing or illegible when filed} & ( 6 )\end{matrix}$$

Note that an angle θ_{Q} represents an angle of rotation of the phase grating 4 (i.e., angle obtained by subtracting an angle formed by the phase grating 4 and the optical axis 20 from 90°); an angle θ_{R} is an angle of rotation of the shield grating 5; and an angle θ_{S} is an angle of rotation of the X-ray detector 6. In other words, in a case in which the angle formed by the source grating 2 and the optical axis 20 changes from the first angle to the second angle, θ_{Q} is a difference between an angle formed by the optical axis 20 and the phase grating 4 when the optical axis 20 and the source grating 2 form the first angle and an angle formed by the optical axis 20 and the phase grating 4 when the optical axis 20 and the source grating 2 form the second angle. Hereinafter, this may be referred to as “a difference in angle formed by an optical axis and a diffraction grating between the time when the optical axis and the source grating form the first angle and the time when the optical axis and the source grating form the second angle” in some cases. The angles θ_{R} and θ_{S} are defined in a similar manner.

In the third exemplary embodiment, θ (the angle of rotation of the source grating 2)=θ_{Q}=θ_{R}=θ_{S}. In addition, the shield grating 5 and the X-ray detector 6 are in close contact with each other in the third exemplary embodiment, and it is considered that L2=L3. Thus, ΔL2=ΔL3. In this manner, even if L2≠L3 in a strict sense, if a difference between L2 and L3 is extremely small, defining as ΔL2=ΔL3 has little influence.

By implementing the third exemplary embodiment, information on moire having more uniform contrast than that of the first exemplary embodiment can be obtained as a detection result.

### Exemplary Embodiment

In an exemplary embodiment, the X-ray Talbot interferometer of the second exemplary embodiment will be described in further detail.

FIG. 9 illustrates the configuration according to the exemplary embodiment. X-rays emitted from the X-ray source 1 pass through the source grating 2 and the inspection object 3 and are diffracted by the phase grating 4. The resulting X-rays form a self-image on the shield grating 5, and as part of the self-image is blocked by the shield grating 5, moire is formed. The formed moire is then detected by the X-ray detector 6. The X-ray detector 6 detects the moire in accordance with an instruction transmitted to the X-ray detector 6 from the control unit 8. In addition, data detected by the X-ray detector 6 is transmitted to the calculator 7 serving as an operation unit, and a differential phase contrast image of the inspection object 3 is formed. Although each of the phase grating 4 and the shield grating 5 has a curved shape that follows along the wavefront of the incident X-rays in the second exemplary embodiment, in reality, each of the phase grating 4 and the shield grating 5 is only slightly curved as compared with a planar shape, as indicated by the radius of curvature that will be described later. In addition, a feature in which each of the gratings is curved is not essential in the exemplary embodiment of the present invention, and thus illustration of such a shape is omitted in FIG. 9 and in the subsequent drawings.

The source grating 2 is rotated about the center of the source grating 2 by the actuator 10, and thus the angle formed by the source grating 2 and the optical axis 20 varies. In addition, the actuator 10 causes the source grating 2 to move along the optical axis 20, and thus the distance between the X-ray source 1 and the source grating 2 varies.

The exemplary embodiment will now be described in detail while indicating specific numerical values employed in the configuration described above.

The energy of the X-rays emitted from the X-ray source 1 is set to 35 keV (3.54×10⁻² nm).

The source grating 2 is square in shape with each side measuring 12 mm. Each of the phase grating 4 and the shield grating 5 have an effective region that is square in shape with each side measuring 150 mm. The X-ray detector 6 also has a detectable effective region that is square in shape with side measuring 150 mm.

In the phase grating 4, phase shift portions 31 and phase reference portions 32 are arranged in a checkered grid pattern as illustrated in FIG. 10, and the period (distance between adjacent phase shift portions) is set as d1=10 μm. The phase grating 4 is formed of silicon, which has high X-ray transmittance, and protrusions are formed periodically on the surface of the grating so as to form the phase shift portions 31 and the phase reference portions 32. The phase grating 4 is a it grating, and in a case in which the phase grating 4 is irradiated with the X-rays of 35 keV, a phase shift amount turns out to be 33 μm while a difference in refractive index (5.37×10⁻⁷) between the phase grating 4 and the air is taken into consideration. In other words, the phase grating 4 is fabricated such that each phase shift portion 31 has a height (protrusion) of 33 μm.

In addition, each of the source grating 2 and the shield grating 5 is a parallel cross pattern grating in which protrusions are formed on a silicon substrate as illustrated in FIGS. 11 and 12, and the protrusions are formed of Au having high X-ray absorptivity so that the X-rays are blocked by the protrusions and transmitted through locations aside from the protrusions (i.e., planar portions).

The periods of the source grating 2 and the shield grating 5 are set as d2=16 μm and d3=10.5 μm, respectively, and the height of each protrusion is set to 120 μm. Here, the period refers to the distance between the center of a given protrusion and the center of an adjacent protrusion closest to the given protrusion. In addition, the widths of the protrusion and the planer portion are set to be in a ratio of 1:1.

Subsequently, each of the gratings described above is disposed. The source grating 2 and the phase grating 4 are disposed such that the distance (L0) between the X-ray source 1 and the source grating 2 is 100 mm and the distance (L1) between the X-ray source 1 and the phase grating 4 is 1000 mm. Then, since the Talbot distance is 581 mm in the X-ray Talbot interferometer of the exemplary embodiment, the shield grating 5 is disposed such that the distance (L2) between the X-ray source 1 and the shield grating 5 is 1581 mm. The phase grating 4 and the shield grating 5 are each curved in a circular arc shape having respective radii of 1000 mm and 1581 mm with the focal point of the X-ray source 1 being the center.

The X-ray detector 6 is disposed in close contact with the shield grating 5 at the center thereof, and thus the distance between the X-ray source 1 and the X-ray detector 6 is considered to be equal to L2.

FIG. 13 illustrates calculated transmittance of incident X-rays that can actually pass through an area on the source grating 2 through which the X-rays are supposed to be transmitted in a case in which the X-ray source 1, the source grating 2, the phase grating 4, the shield grating 5, and the X-ray detector 6 are disposed in the manner described above in the X-ray Talbot interferometer of the exemplary embodiment. Here, for convenience of calculation, the focal spot size of the X-rays is set to 0.

Note that the assumption is that the optical axis 20 passes through the center of the source grating 2 in the initial state. In addition, the effective region (effective length at one side) of the source grating 2 in the initial state can be obtained through the following equation on the basis of the above-described disposition of the source grating 2.

150×100/1581=9.49 mm

In other words, in FIG. 13, incident X-rays that pass through the source grating 2 around the four corners pass therethrough at positions that are each spaced apart from the center by X (distance from the center in the first direction)=4.74 mm and Y (distance from the center in the second direction)=4.74 mm. Thus, with the light amount at the center portion being 100%, only the light amount in less than 10% can be obtained around each of the four corners. Here, the assumption is that the optical axis 20 of the X-rays lies along the horizontal plane; a direction that lies along the horizontal plane and that is orthogonal to the optical axis 20 is the X-axis; and a direction that is perpendicular to the horizontal plane is the Y-axis.

Thus, it is understood that the transmittance of the incident X-rays that actually pass through an area through which the incident X-rays are supposed to be transmitted decreases as the distance from the optical axis 20 increases along the surface of the source grating 2, and the X-rays are hardly transmitted through the source grating 2 at a peripheral portion of the source grating 2.

Subsequently, the source grating 2 is rotated and translated along the optical axis 20 in accordance with Expression (1) and Expression (2). Hereinafter, a case in which the X-rays are incident normally on the source grating 2 around a middle portion of each of the four sides of the effective region (i.e., a portion at which a given one of the four sides intersects with the X-axis or the Y-axis) will be described.

In a case in which the X-rays are incident on the source grating 2, for example, at a position where X=4.5 mm and Y=0 mm, corresponding to one of the aforementioned portions, it turns out that θ=2.58° and ΔL0=1.01 mm on the basis of the above-described disposition of the grating. Thus, the source grating 2 is rotated such that the angle formed by the source grating 2 and the optical axis 20 became 90°−θ, or 87.4°.

At this time, calculating a transmittance distribution of the X-rays through the source grating 2 (i.e., actual transmittance of incident X-rays that have passed through an area through which the X-rays are supposed to be transmitted) leads to the result as illustrated in FIG. 14.

In a similar manner, transmittance distributions around the four corners of the effective region on the source grating 2 are calculated. Here, a case in which the X-rays are incident normally on the source grating 2 at a position where X=4.5 mm and Y=4.5 mm will be described. In this case, the distance between the optical axis 20 and the aforementioned XY coordinates (4.5, 4.5) is √2×4.5 mm. Then, calculation through Expression (1) and Expression (2) leads to θ=3.64° and ΔL0=0.20 mm.

In this case, θ represents an angle formed by a straight line connecting the X-ray source 1 and the XY coordinates (4.5, 4.5) and the optical axis 20, and the source grating 2 is rotated such that the angle formed by a straight line connecting the XY coordinates (4.5, 4.5) and the center of the source grating 2 and the optical axis 20 becomes 90°−θ, or 86.4°. At this time, a transmittance distribution of the incident X-rays on the source grating 2 is illustrated in FIG. 15.

Thereafter, a transmittance distribution of the incident X-rays at each of nine points (one at the center portion (initial state), which is a point of intersection of diagonal lines; four at respective four sides at the middle portions thereon; and four at four corners of the effective region of the source grating 2) along the surface of the source grating 2 has been calculated in a similar manner, and nine images obtained through the calculation are integrated. Thus, the transmittance as illustrated in FIG. 16 is obtained.

The result described above reveals that the transmittance around a position where X=4.5 mm and Y=4.5 mm that has been, for example, approximately 10% in the initial state has increased to 65%.

In other words, an advantageous effect of the exemplary embodiment is apparent when FIG. 16 illustrating the result of integration of data from the aforementioned nine points is compared with FIG. 13 illustrating the transmittance of the X-rays in a case in which the source grating 2 is neither rotated nor translated. In addition, by varying the angle formed by the source grating 2 and the optical axis 20 as in the exemplary embodiment, uniformity in in-plane contrast of a moire pattern obtained by the X-ray detector 6 can be improved. Although the source grating 2 has been operated (rotated and moved) to cause the X-rays to be incident normally on the source grating 2 at nine positions within the surface of the source grating 2 and the X-rays have been detected by the X-ray detector 6 in the exemplary embodiment, it is considered that the uniformity in in-plane contrast of an obtained image improves as the number of points at which the operations are carried out increases. Thus, it is preferable to carry out a continuous operation, or in other words, to carry out the operations (rotation and movement) of the source grating 2 across the entire area of the surface of the source grating 2 while the X-ray detector 6 is detecting the X-rays. In this manner, with the exemplary embodiment, contrast of moire (self-image) in an area spaced apart from the optical axis can be improved as compared with that of the existing X-ray Talbot interferometer while using a source grating that can be fabricated more easily than those described in Japanese Patent Application Laid-Open No. 2007-203066 and Japanese Patent Application Laid-Open No. 2007-203064.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-050558, filed Mar. 13, 2013, which is hereby incorporated by reference herein in its entirety.

What is claimed is:

1. An X-ray Talbot interferometer, comprising:
a source grating configured to spatially split X-rays emitted from an X-ray source;
a diffraction grating configured to diffract the X-rays from the source grating to form an interference pattern;
an X-ray detector configured to detect the X-rays from the diffraction grating; and
an angle varying unit configured to vary an angle formed by an optical axis and at least one periodic direction of the source grating, the optical axis being a center of a flux of the X-rays from the X-ray source.

2. The X-ray Talbot interferometer according to claim 1,
wherein the angle varying unit varies the angle formed by the optical axis and the periodic direction from a first angle to a second angle, and
wherein the X-ray detector detects the X-rays at least when the optical axis and the periodic direction form the first angle and when the optical axis and the periodic direction form the second angle.

3. The X-ray Talbot interferometer according to claim 2,
wherein the X-rays are incident normally on the source grating at a center of a first area of the source grating when the optical axis and the periodic direction form the first angle, and
wherein the X-rays are incident normally on the source grating at a center of a second area of the source grating when the optical axis and the periodic direction form the second angle, the second area being different from the first area.

4. The X-ray Talbot interferometer according to claim 1,
wherein the angle varying unit varies the angle formed by the optical axis and the periodic direction by moving the source grating.

5. The X-ray Talbot interferometer according to claim 1, further comprising:
an X-ray source configured to irradiate the source grating with X-rays,
wherein the angle varying unit varies the angle formed by the optical axis and the periodic direction by moving the X-ray source.

6. The X-ray Talbot interferometer according to claim 1,
wherein, while the X-ray detector detects the X-rays, the angle varying unit varies the angle formed by the optical axis and the periodic direction.

7. The X-ray Talbot interferometer according to claim 1, further comprising:
a distance varying unit configured to vary a distance between the X-ray source and the source grating,
wherein, as the angle varying unit varies the angle formed by the optical axis and the periodic direction from a first angle to a second angle, the distance varying unit varies the distance between the X-ray source and the source grating.

8. The X-ray Talbot interferometer according to claim 7,
wherein a difference between the first angle and the second angle is θ, and
wherein, when the angle varying unit varies the angle formed by the optical axis and the periodic direction from the first angle to the second angle, the distance varying unit varies the distance between the X-ray source and the source grating from L0 to (L0+ΔL0), where
$$Δ L 0 = L 0 \times ( \frac{1}{cos θ} - 1 )$$

9. The X-ray Talbot interferometer according to claim 7,
wherein the distance varying unit varies the distance between the X-ray source and the source grating such that X-rays that are incident on the source grating at a center of a first area of the source grating when the optical axis and the periodic direction form the first angle are incident on the source grating at the center of the first area when the optical axis and the periodic direction form the second angle.

10. The X-ray Talbot interferometer according to claim 1,
wherein the source grating includes periodic directions in a first direction and a second direction, the second direction intersecting with the first direction, and
wherein the angle varying unit varies at least one of an angle formed by the optical axis and the first direction and an angle formed by the optical axis and the second direction.

11. The X-ray Talbot interferometer according to claim 10,
wherein the angle varying unit varies the angle formed by the optical axis and the first direction and the angle formed by the optical axis and the second direction.

12. The X-ray Talbot interferometer according to claim 1, further comprising:
a shield grating configured to block part of the X-rays that form the interference pattern,
wherein the X-ray detector detects the X-rays from the shield grating.

13. The X-ray Talbot interferometer according to claim 12,
wherein the angle varying unit varies at least one of the angle formed by the optical axis and the periodic direction of the diffraction grating and an angle formed by the optical axis and a periodic direction of the shield grating.

14. The X-ray Talbot interferometer according to claim 13,
wherein at least one of the diffraction grating and the shield grating has a curved shape that follows an arc with a center being a focal point of the X-ray source.

15. The X-ray Talbot interferometer according to claim 12, further comprising:
a distance varying unit configured to vary a distance between the diffraction grating and the X-ray source, a distance between the shield grating and the X-ray source, and a distance between the X-ray detector and the X-ray source,
wherein, when the angle varying unit varies the angle formed by the optical axis and the periodic direction of the source grating from a first angle to a second angle, the distance varying unit varies the distance between the diffraction grating and the X-ray source from L1 to (L1+ΔL1), the distance between the shield grating and the X-ray source from L2 to (L2+ΔL2), and the distance between the X-ray detector and the X-ray source from L3 to (L3+ΔL3), where
$$Δ L 1 = L 1 \times ( \frac{1}{cos {θ}_{Q}} - 1 )$$
$$Δ L 2 = L 2 \times ( \frac{1}{cos {θ}_{\text{?}}} - 1 )$$
$$Δ L 3 = L 3 \times ( \frac{1}{cos {θ}_{\text{?}}} - 1 )$$
$$\text{?} \text{indicates text missing or illegible when filed}$$
wherein θ_{Q} is a difference in the angle formed by the optical axis and the diffraction grating between a time when the optical axis and the periodic direction of the source grating form the first angle and a time when the optical axis and the periodic direction of the source grating form the second angle, θ_{R} is a difference in the angle formed by the optical axis and the shield grating between a time when the optical axis and the periodic direction of the source grating form the first angle and a time when the optical axis and the periodic direction of the source grating form the second angle, and θ_{S} is a difference in the angle formed by the optical axis and the X-ray detector between a time when the optical axis and the periodic direction of the source grating form the first angle and a time when the optical axis and the periodic direction of the source grating form the second angle.

16. The X-ray Talbot imaging system, comprising:
the X-ray Talbot interferometer according to claim 1; and
an operation unit which carries out operations using results of detection by the X-ray detector.
